(19) United States
(12) Patent Application Publication
(10) Pub. No.: US 2008/0268185 A1
(43) Pub. Date: Oct. 30, 2008

(54) Multi-layered porous ink-jet recording media

(76) Inventors: Tienteh Chen, San Diego, CA (US); Tony Pidding, San Diego, CA (US); Rajasekar (Raj) Vaidyanathan, San Diego, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/799,207

(22) Filed: Apr. 30, 2007

(51) Int. Cl. B41M 3/12; B41M 5/00

(52) U.S. Cl. 428/32.24; 427/146

(57) ABSTRACT

An ink-jet media sheet imparting superior image quality and permanence is disclosed. Such a sheet may comprise a substrate consecutively coated with a porous ink-absorbing layer and a porous ink-receiving layer, where the specific surface area of the particulates of the ink-absorbing layer is less than that of the ink-receiving layer, e.g., the particulates are generally smaller in the ink-receiving layer. The porous coating layers can comprise semi-metal or metal oxide particulates and may further include other surface treatment or reactive groups having functional moieties to promote fixing and localizing printed colorants. Images printed on these media sheets exhibit good fastness to water, ozone, and humidity as well as improved color gamut and black intensity.

### BACKGROUND OF THE INVENTION

Ink-jet inks typically comprise an ink vehicle and a colorant, the latter of which may be a dye or a pigment. Dye-based ink-jet inks used in photographic image printing are usually water-soluble dyes. As a result, such dye-based ink-jet inks are usually not very water fast, i.e. images tend to shift in hue and edge sharpness is reduced upon exposure to humid conditions, especially when printed on media substrates having a porous ink-receiving coating. In addition, images created from these water-soluble dye-based ink-jet inks tend to fade over time, such as when exposed to ambient light and/or air. Pigment-based inks on the other hand, allow the creation of images that are vastly improved in humid fastness and image fade resistance. Pigment-based images, however, are inferior to dye-based ink-jet inks with respect to the desirable trait of color saturation and penetration of colorant below a coating surface.

Print media surfaces play a key role in fade properties, humid fastness, and the quality of ink-jet produced printed images. Thus, for a given ink, the degree of air fade, humid fastness, haze, and image quality in general can be dependent on the chemistry of the media surface. As a result, many ink-jet inks can be made to perform better in one or more of these areas when an appropriate media surface is used.

There are benefits of treating silica or other particulates with cationic agents in connection with ink-jet coatings. However, increasing the level of these cationic agents can also result in a decreased porosity, increased haze, lower gamut, and precipitation of ink dye or pigments on the surface of the media, often resulting in poor smudging and poor color properties. Thus, there is a need for ink-jet media coatings that provide improved image quality and permanence while preserving good color printing performance.

### DETAILED DESCRIPTION OF THE PREFERRED EMBODIMENT(S)

It has been recognized that a need exists for coated ink-jet media having properties that enhance the permanence of printed images (e.g. water fastness, humid fastness, and ozone fastness), as well as image quality, while providing good printing performance and rapid drying. In light of this recognition, the present invention provides ink-jet media in which a porous ink-absorbing layer and a porous ink-receiving layer are deposited onto a substrate.

In describing and claiming the present invention, the following terminology will be used:

The singular forms “a,” “an,” and “the” include plural referents unless the context clearly dictates otherwise. Thus, for example, reference to “a colorant” includes reference to one or more of such materials.

“Media substrate” or “substrate” includes any substrate that can be coated with coating compositions (such as a porous ink-absorbing layer and a porous ink-receiving layer), and can include papers, overhead projector plastics or films, coated papers such as photobase, fabric, art paper such as water color paper, or the like.

A “porous ink-absorbing layer” or “ink-absorbing layer” includes semi-metal oxide particulates or metal oxide particulates. The particulates can be bound together by a binder. The surfaces of the particulates may also be modified with one or more reagents, such as organosilane reagents and trivalent or tetravalent metal salts. Other components, such as formulating agents and/or mordants, can also be present in this layer.

A “porous ink-receiving layer” or “ink-receiving layer” also includes semi-metal oxide particulates or metal oxide particulates. This layer is typically applied as a topcoat over the ink-absorbing layer. The particulates may be bound together by a binder. The surfaces of the particulates may also be modified with one or more reagents, such as organosilane reagents. Other components, such as formulating agents and/or mordants, can also be present in this layer.

“Organosilane” or “organosilane reagent” includes compositions that comprise a functional moiety (or portion of the reagent that provides desired modified properties to an inorganic particulate surface), which is covalently attached to a silane grouping. The organosilane reagent can become covalently attached or otherwise attracted to the surface of semi-metal oxide particulates or metal oxide particulates. The functional moiety portion of the organosilane reagent can be directly attached to the silane grouping, or can be appropriately spaced from the silane grouping, such as by from 1 to 10 carbon atoms or other known spacer groupings. The silane grouping of the organosilane reagent can be attached to semi-metal oxide or metal oxide particulates of the porous media coating composition through hydroxyl groups, halide groups, or alkoxy groups present on the reagent. Alternatively, in some instances, the organosilane reagent can be merely attracted to the surface of the inorganic particulates. In accordance with embodiments of the present invention, the functional moiety can be any moiety that is desired for a particular application. In one embodiment, the functional moiety can be a primary, tertiary, or quaternary amines. Without limitation, amines are particularly useful as the functional moiety when the pH of the porous ink-receiving layer and/or the pH of the ink-absorbing layer are less than about 6, and often from about 3 to about 6. Such pH values cause the amines to be protonated or cationic, which can attract anionic colorants that may be present in ink-jet inks.

“Aluminum chlorohydrate,” “ACH,” “polyaluminum chloride,” “PAC,” “polyaluminum hydroxychloride,” or the like, refers to a class of soluble aluminum products in which aluminum chloride has been partly reacted with a base. The relative amount of OH compared to the amount of Al can determine the basicity of a particular product. The chemistry of ACH is often expressed in the form Alₙ(OH)ₘCl₍₃ₙ₋ₘ₎, wherein n can be from 1 to 50, and m can be from 1 to 150. Basicity can be defined by the term m/(3n) in that equation. ACH can be prepared by reacting hydrated alumina AlCl₃ with aluminum powder in a controlled condition. The exact composition depends upon the amount of aluminum powder used and the reaction conditions. Typically, the reaction can be carried out to give a product with a basicity of 40% to 83%. ACH can be supplied as a solution, but can also be supplied as a solid.

There are other ways of referring to ACH, which are known in the art. Typically, ACH comprises many different molecular sizes and configurations in a single mixture. An exemplary stable ionic species in ACH can have the formula [Al₁₂(OH)₂₄AlO₄(H₂O)₁₂]⁷⁺. Other examples include [Al₆(OH)₁₅]³⁺, [Al₈(OH)₂₀]⁴⁺, [Al₁₃(OH)₃₄]⁵⁺, [Al₂₁(OH)₆₀]³⁺, etc. Other common names used to describe ACH or components that can be present in an ACH composition include Aluminum chloride hydroxide (8Cl); A 296; ACH 325; ACH 331; ACH 7-321; Aloxicoll; Aloxicoll LR; Aluminium hydroxychloride; Aluminol ACH; Aluminum chlorhydrate; Aluminum chlorohydroxide; Aluminum chloride hydroxide oxide, basic; Aluminum chloride oxide; Aluminum chlorohydrate; Aluminum chlorohydrol; Aluminum chlorohydroxide; Aluminum hydroxide chloride; Aluminum hydroxychloride; Aluminum oxychloride; Aquarhone; Aquarhone 18; Astringen; Astringen 10; Banoltan White; Basic aluminum chloride; Basic aluminum chloride, hydrate; Berukotan AC-P; Cartafix LA; Cawood 5025; Chlorhydrol; Chlorhydrol Micro-Dry; Chlorhydrol Micro-Dry SUF; E 200; E 200 (coagulant); Ekoflock 90; Ekoflock 91; GenPac 4370; Gilufloc 83; Hessidrex WT; HPB 5025; Hydral; Hydrofugal; Hyper Ion 1026; Hyperdrol; Kempac 10; Kempac 20; Kemwater PAX 14; Locron; Locron P; Locron S; Nalco 8676; OCAL; Oulupac 180; PAC; PAC (salt); PAC 100W; PAC 250A; PAC 250AD; PAC 300M; PAC 70; Paho 2S; PALC; PAX; PAX 11S; PAX 16; PAX 18; PAX 19; PAX 60p; PAX-XL 1; PAX-XL 19; PAX-XL 60S; PAX-XL 61S; PAX-XL 69; PAX-XL 9; Phacsize; Phosphonorm; (14) Poly(aluminum hydroxy) chloride; Polyaluminum chloride; Prodefloc AC 190; Prodefloc AL; Prodefloc SAB 18; Prodefloc SAB 18/5; Prodefloc SAB 19; Purachem WT; Reach 101; Reach 301; Reach 501; Sulzfloc JG; Sulzfloc JG 15; Sulzfloc JG 19; Sulzfloc JG 30; TAI-PAC; Taipac; Takibine; Takibine 3000; Tanwhite; TR 50; TR 50 (inorganic compound); UPAX 20; Vikram PAC-AC 100S; WAC; WAC 2; Westchlor 200; Wickenol 303; Wickenol CPS 325 Aluminum chlorohydrate Al₂ClH₅O₅ or Al₂(OH)₅Cl.2H₂O or [Al(OH)₂Cl]ₓ or Al₆(OH)₁₅Cl₃; Al₂(OH)₅Cl]ₓ Aluminum chlorohydroxide; Aluminum hydroxychloride; Aluminum chloride, basic; Aluminum chloride hydroxide; [Al₂(OH)ₙCl₁₆₋ₙ]ₘ; [Al(OH)₃]ₙAlCl₃; or Alₙ(OH)ₘCl₍₃ₙ₋ₘ₎ (where generally, 0<m<3n); for example. It is believed that contacting a silica particle with an aluminum compound as described above causes the aluminum compound to become associated with or bind to the surface of the silica particles. This can be either by covalent association or through an electrostatic interaction to form cationic charged silica, which can be measured by a Zeta potential instrument.

“Binder” or “polymeric binder” includes any substance that can be used to bind semi-metal oxide or metal oxide particulates together. The binder is typically used in an amount that binds the particulates together, but still leaves voids between the particulates for receiving ink or allowing ink to pass between them. Typically, binder material that can be used includes polyvinyl alcohol, copolymer of polyvinylalcohol, derivatives of polyvinylalcohol, polyethylene oxide, gelatin, PVP, copolymer of polyvinylpyrrolidone, and/or low glass transition temperature (T_{g}<20° C.) emulsion polymers and polyurethanes, for example. The binder can be present in the porous ink-absorbing layer and/or the porous ink-receiving layer at from about 0.1 wt % to about 40 wt %.

The term “ink-jet ink” refers to ink-jettable compositions that include a liquid vehicle and a colorant, such as a dye and/or a pigment. Optionally, other ingredients can be carried by the liquid vehicle as well, such as latex polymers, polymer dispersions, UV curable materials, plasticizers, antioxidants, light stabilizers, oxygen scavengers, etc.

As used herein, “liquid vehicle” can include liquid compositions that can be used to carry dyes and/or other substances to a substrate. Liquid vehicles are well known in the art, and a wide variety of ink vehicles may be used in accordance with embodiments of the present invention. Such ink vehicles can include a mixture of a variety of different agents, including without limitation, surfactants, solvents, co-solvents, buffers, biocides, viscosity modifiers, sequestering agents, stabilizing agents, and water.

As used herein, “water fastness” refers to an inks exhibited degree of water resistance after printing on a substrate. Typically, this property is measured after the ink has dried, and measures the tendency of the ink to smear or otherwise change location in the presence of moisture.

The term “colorant” includes both dyes and pigments.

As used herein, a plurality of components may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Ratios, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of about 1 wt % to about 20 wt % should be interpreted to include not only the explicitly recited concentration limits of 1 wt % to about 20 wt %, but also to include individual concentrations such as 2 wt %, 3 wt %, 4 wt %, and sub-ranges such as 5 wt % to 15 wt %, 10 wt % to 20 wt %, etc.

With this in mind, the present invention is directed to an ink-jet media sheet, which comprises a substrate, a porous ink-absorbing layer deposited onto the substrate, and a porous ink-receiving layer deposited on the ink absorbing layer. Both the ink-absorbing layer and the ink-receiving layer may comprise metal oxide particulates, semi-metal oxide particulates, or a combination thereof, as well as an organosilane reagent. The ink-absorbing layer can further comprise a trivalent or tetravalent metal salt, e.g., aluminum chlorohydrate. Ink-jet ink that is printed onto such an ink-jet media sheet will pass substantially through the porous ink-receiving layer, and into the porous ink-absorbing layer, filling voids between the particulates in that layer. Desirable image qualities, such as color gamut, black density, gloss, gloss uniformity, water fastness, color fastness, and sharpness may be enhanced by such a coated substrate when the topmost ink-receiving layer becomes dry to the touch quickly after ink is printed thereon, and the ink is collected in the voids of the ink-absorbing layer holds.

In another embodiment, a method of preparing an ink-jet media sheet can comprise applying a porous ink-absorbing layer on a media substrate at from 5 g/m² to 30 g/m², and applying a porous ink-receiving layer on the porous ink-absorbing layer at from 1 g/m² to 20 g/m². The porous ink-absorbing layer can comprise metal oxide particulates or semi-metal oxide particulates and an organosilane reagent, and aluminum chlorohydrate; and the porous ink-receiving layer can comprise metal oxide particulates or semi-metal oxide particulates and an organosilane reagent.

Porous Media Coatings

Porous media typically includes a substrate and a porous ink-receiving layer deposited on the substrate. However, in accordance with embodiments of the present invention, at least two different porous media coatings are applied to the substrate, namely, porous media coatings that are used to form i) a porous ink-absorbing layer, and ii) a porous ink-receiving layer.

As similar components are used to prepare each layer, many of the elements of each layer will be discussed together herein. It is noted that these two layers can be typically different in composition, surface area, and/or thickness.

The substrate, which supports both the ink-absorbing layer and the ink-receiving layer can be paper, plastic, coated paper, fabric, art paper, or other known substrate used in the ink-jet printing arts. In one embodiment, photobase can be used as the substrate. Photobase is typically a three-layered system comprising a single layer of paper sandwiched by two polymeric layers, such as polyethylene layers. A hybrid photobase with only one polymeric layer on the image side and pigment coating on the backside can also be used.

With respect to the porous ink-absorbing layer and the porous ink-receiving layer, semi-metal oxide particulates or metal oxide particulates, and optionally, binder, mordants, and/or other porous coating composition agents can be present in each. Both layers can utilize the same type of semi-metal oxide particulates or metal oxide particulates. For example, in each layer, the semi-metal oxide particulates or metal oxide particulates can be independently selected from silica, alumina, boehmite, silicates (such as aluminum silicate, magnesium silicate, and the like), titania, zirconia, calcium carbonate, clays, or combinations thereof. More commonly, the particulates are alumina or silica. According to a preferred embodiment, the particulates of both layers are silica. Each of these inorganic particulates can be dispersed throughout a porous coating composition, which can be applied to a media substrate to form either the porous ink-absorbing layer or porous ink-receiving layer.

As the semi-metal or metal oxide particulates are not self-adherent, typically, a binder is added to the composition to bind the particulates together. An amount of binder is typically added that provides a balance between binding strength and maintaining particulate surface voids and inter-particle spaces for allowing ink to be received. Accordingly a binder may be present in either the ink-absorbing layer or the ink-receiving layer or in both layers. Exemplary binders for use according to the present invention are polyvinyl alcohols such as water-soluble copolymers of polyvinyl alcohols including copolymer of polyvinyl alcohol and poly(ethylene oxide) and copolymer of polyvinyl alcohol and polyvinyl amine, cationic polyvinyl alcohols, acetoacetylated polyvinyl alcohols, and silyl-modified polyvinyl alcohol; also polyvinyl acetate, polyvinyl pyrrolidone, modified starches, water soluble cellulose derivatives, polyacrylamides, casein, gelatin, soybean protein, conjugated diene copolymer latexes, acrylic polymer latexes, vinyl polymer latexes, functional group-modified latexes, aqueous binders of thermosetting resins, and synthetic resin. In a particular embodiment, the binder may be present in either layer (or both) in an amount of about 0.1 wt % to about 40 wt %.

To produce the desired printing results, the respective layers of the media sheet should be made so as to exhibit certain properties. For example, one function of the ink-absorbing layer is to provide fast absorption of inks into the porous media to substantially reduce ink flooding and/or coalescence. One function of the ink-receiving layer is to provide desired image quality like color gamut, optical density, such as black optical density (KOD), coalescence, and gloss. The relative properties of the ink-absorbing layer and the ink-receiving layer may be determined in a number of ways. One is by choosing semi-metal oxide particulates or metal oxide particulates of appropriate sizes. The size of particulate used in a layer affects the amount of surface area available to interact with printed ink, as well as the volume of spaces between particles in which ink can be contained. Therefore important media characteristics may be determined by choosing particulates having appropriate surface areas in a given layer, and also by choosing appropriate relative surface areas between layers. Specific surface areas of coating particulates may be assessed using the Brunauer-Emmett-Teller (BET) algorithm. According to a preferred embodiment of the present invention, the porous ink-receiving layer can often have a greater specific surface area than the porous ink-absorbing layer, e.g. the ink-receiving layer often has smaller particle sizes, though this is not required. In some embodiments, both layers can have about the same particle size. More specifically, the ink-receiving layer can comprise semi-metal oxide particulates or metal oxide particulates having a specific surface area of at least 200 m²/g, or preferably from 250 m²/g to about 800 m²/g. According to the same embodiment, the ink-absorbing layer can comprise semi-metal oxide particulates or metal oxide particulates having a specific surface area of no more than about 300 m²/g. In each case, the specific surface area of the particulates of ink-absorbing layer can be less than that of the ink-receiving layer, e.g., typically the particle size of the particulates in the ink-receiving layer is smaller than those present in the ink-absorbing layer. However, it is also noted that the specific surface area of each layer can be about the same as well in some embodiments.

The performance of the ink-jet media sheet can also depend on the thickness of the respective layers. For example, crispness and water fastness of a printed image may be enhanced where the ink-receiving layer is thin enough for the ink to substantially pass through, while the ink-absorbing layer has sufficient volume to hold the ink without flooding. Accordingly, in one embodiment of the present invention the porous ink-absorbing layer of the present invention is be deposited onto the substrate at a thickness of from 5 g/m² to 30 g/m². In the same or in another embodiment, the porous ink-receiving layer is deposited on the ink-absorbing layer at a thickness of from 1 g/m² to 20 g/m².

Another way of imparting the desired characteristics to the respective layers is by adding reagents to the layers. The reagent molecules may be interspersed throughout the layer, e.g. suspended or dissolved in a binder, or they may be localized to the surfaces of the particulates in a layer. Such localization may occur due to attractive forces between the reagent molecules and those at the surface of the particles. The surfaces of the particles may be modified by covalent attachment of reagent molecules thereto, either directly or via one or more spacer molecules. Reagents that may be added to the layers of the media sheet of the present invention include organosilanes, such as amine-functionalized silanes, e.g., primary, tertiary, or quaternary amines. Often the organosilane reagent is an aminosilane reagent. Further, particularly in the ink-absorbing layer, an aluminum chlorohydrate can be included therein.

Surface Modification and/or Treatment of Semi-Metal Oxide Particulates or Metal Oxide Particulates

In accordance with embodiments of the present invention, organosilane reagents can be used to modify semi-metal oxide particulates and metal oxide particulates. For example, organosilane reagents can be added to surface-activated silica to add additional positively charged moieties to the surface, or to provide another desired function at or near the surface, e.g., ultraviolet absorbers, chelating agents, hindered amine light stabilizers, reducing agents, hydrophobic groups, ionic groups, buffering groups, or functionalities for a subsequent reaction.

Organosilanes that may be used include methoxysilanes, halosilanes, ethoxysilanes, alkylhalosilanes, alkylalkoxysilanes, or other known reactive silanes, any of which may be further modified with one or more functional group including amine, epoxy, or heterocyclic aromatic groups. A preferred organosilane for use in accordance with the present invention is aminosilane, in which one or more of the functional moieties is an amine. To exemplify aminosilane reagents that can be used to modify such particulates, Formula I is provided, as follows:

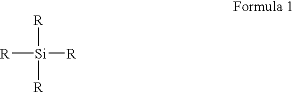

In Formula I above, from 0 to 2 of the R groups can be H, —CH₃, —CH₂CH₃, or —CH₂CH₂CH₃; from 1 to 3 of the R groups can be hydroxy, halide, or alkoxy; and from 1 to 3 of the R groups can be an amine. As colorants present in ink-jet inks are often anionic, amines that are protonated on the surface of the media can be preferred for many ink-jet applications. Additionally in Formula 1, R can also include a spacer group that separates the amine functionality from the silane group, as is known in the art. Examples of aminosilane reagents include 3-aminopropyltrimethoxysilane, 3-aminopropyltriethoxysilane, 3-aminoethylaminopropyltrimethoxysilane, 3-aminoethylaminopropyltriethoxysilane, 3-aminoethylaminoethylaminopropyltrimethoxysilane, 3-aminoethylaminoethylaminopropyltriethoxysilane, 3-aminopropylsilsesquioxane, (n-Butyl)-3-aminopropyltrimethoxysilane, (n-Butyl)-3-aminopropyltriethoxysilane, bis-(3-trimethoxysilylpropyl)amine, N-benzyl-N-aminoethyl-3-aminopropyltrimethoxysilane hydrochloride, N-phenyl-3-aminopropyltrimethoxysilane, N-(2-aminoethyl-3-aminopropyltrimethoxysilane, 3-(triethoxysilylpropyl)-diethylenetriamine, poly(ethyleneimine) trimethoxysilane, or the like.

Though many different types of functional moieties can be attached to the semi-metal oxide particulates or metal oxide particulates for use in the ink-receiving layer and/or the ink-absorbing layer, amines can be particularly useful for ink-jet applications. To illustrate, when the pH of the porous ink-receiving layer and/or the pH of the ink-absorbing layer are less than about 6, and preferably from about 3 to about 5, the amines will typically be protonated, i.e., greater than 50% protonated. This degree of protonation can be determined by one skilled in the art after considering the pKa for the substance at issue. In this regard, pKa can be defined as the pH at which half of the composition is protonated. Such pH values cause most amines to be protonated, and it is in this state, i.e. cationic, where the amines can act to attract anionic colorants that may be present in ink-jet inks.

The aminosilanes of the present invention may be covalently attached to the surface of the semi-metal oxide particulates or metal oxide particulates. The reaction between the aminosilane reagents or other organosilanes and the semi-metal oxide particulates or metal oxide particulates can be performed in either organic solvents or in an aqueous dispersion. This later method can be desirable for manufacturing purposes, as the preparation of a hydrophilic ink-receiving layer can be carried out with a reduced number of steps when each of the steps are carried out in an aqueous environment. The aminosilanes may be directly attached to the particulates, or optionally the attachment may be made through spacer molecules.

As previously noted, the organosilane reagent can be present in both the ink-absorbing layer and the ink-receiving layer. However, the presence of a multivalent salt in the ink-absorbing layer can also provide additional printing and manufacturing benefits. For example, the addition of trivalent or tetravalent salts to print media coatings further provide cationic elements that can promote precipitation and localization of colorant and improve the waterfastness and minimize dye migration. Trivalent or tetravalent salts with metals such as aluminum, chromium, gallium, titanium, and zirconium may be used. In one preferred embodiment, a trivalent aluminum salt, aluminum chlorohydrate (ACH), can be included in the ink-absorbing layer. In accordance with this, it has been recognized that the presence of ACH greatly improves the efficiency of the inorganic oxides treated with aminosilanes in aqueous solution. This being stated, it is also noted that too much ACH tends to deteriorate the image quality, e.g., color gamut and black density, of the dye base ink.

Other additives, such as crosslinkers for the polyvinylalcohol and the plasticizers of the polyvinylalcohol, can also be added. Examples of the crosslinkers for polyvinylalcohol are boric acid, formaldehyde, glutaldehyde, glycoxal, Curesan 199 (BASF), Curesan 200 (BASF). Examples of the plasticizers for polyvinylalcohol include glycerol, ethylene glycol, diethyleneglycol, triethylene glycol, morpholine, methylpyrrolidone, and polyethyleneglycol.

In addition, the porous media coating of this invention may also contain any number of mordants, surfactants, buffers, plasticizers, and/or other additives that are well known in the art. The mordant may be a cationic polymer, such as a polymer having a primary amino group, a secondary amino group, a tertiary amino group, a quaternary ammonium salt group, or a quaternary phosphonium salt group. The mordant may be in a water-soluble form or in a water-dispersible form, such as in latex. The water-soluble cationic polymer may include, but is in no way limited to, a polyethyleneimine, a polyallylamine, a polyvinylamine, a dicyandiamide-polyalkylenepolyamine condensate, a polyalkylenepolyamine-dicyandiamideammonium condensate, a dicyandiamide-formalin condensate, an addition polymer of epichlorohydrin-dialkylamine, a polymer of diallyldimethylammoniumchloride (“DADMAC”), a copolymer of diallyldimethylammoniumchloride-SO₂, polyvinylimidazole, polyvinypyrrolidone, a copolymer of vinylimidazole, polyamidine, chitosan, cationized starch, polymers of vinyl benzyltrimethylqammoniumchloride, (2-methacryloyloxyethyl)trimethyl-ammoniumchloride, and polymers of dimethylaminoethylmethacrylate. Examples of the water-soluble cationic polymers that are commercially available in latex form and are suitable as mordants are TruDot P-2604, P-2606, P-2608, P-2610, P-2630, and P-2850 (available from MeadWestvaco Corp., Stamford, Conn.), and Rhoplex® Primal-26 (available from Rohm and Haas Co., Philadelphia, Pa.). It is also contemplated that cationic polymers having a lesser degree of water-solubility may be used in the ink-receiving layer 4 by dissolving them in a water-miscible organic solvent.

A metal salt, such as a salt of an organic or inorganic acid, an organic metal compound, or a metal complex, may also be used as the mordant. For instance, since aluminum salts are inexpensive and provide the desired properties in the ink-receiving layer 4, an aluminum salt may be used. The aluminum salt may include, but is not limited to, aluminum fluoride, hexafluoroaluminate (for example, potassium salts), aluminum chloride, basic aluminum chloride (polyaluminum chloride), tetrachloroaluminate (for example, sodium salts), aluminum bromide, tetrabromoaluminate (for example, potassium salts), aluminum iodide, aluminate (for example, sodium salts, potassium salts, and calcium salts), aluminum chlorate, aluminum perchlorate, aluminum thiocyanate, aluminum sulfate, basic aluminum sulfate, aluminum sulfate potassium (alum), ammonium aluminum sulfate (ammonium alum), sodium sulfate aluminum, aluminum phosphate, aluminum nitrate, aluminum hydrogenphosphate, aluminum carbonate, polyaluminum sulfate silicate, aluminum formate, aluminum diformate, aluminum triformate, aluminum acetate, aluminum lactate, aluminum oxalate, aluminum isopropionate, aluminum butyrate, ethyl acetate aluminum diisopropionate, aluminum tris(acrylacetonate), aluminum tris(ethylacetoacetate), and aluminum monoacetylacetonate-bis(ethylaceto-acetate). The mordant can be a quaternary ammonium salt, such as a DADMAC derivative; an aluminum salt, such as aluminum triformate or aluminum chloride hydrate; or a cationic latex that includes quaternary ammonium functional groups, like TruDot P-2608. These are commercially available from numerous sources, such as BASF Corp. (Mount Olive, N.J.), Ciba Specialty Chemicals (Basel, Switzerland), and MeadWestvaco Corp. (Stamford, Conn.).

Ink-Jet Inks for Use with Ink-Jet Media Sheets

In each of the above embodiments, typical ink-jet inks known in the art can be printed on these media sheets with favorable results. Such inks include a liquid vehicle and a pigment or a dye. The liquid vehicle formulations that can be used in the inks printed on the media sheets of the present invention can include water and one or more co-solvent, present in total at from 5.0 wt % to 50.0 wt % by weight. One or more non-ionic, cationic, and/or anionic surfactant can also be present, and if present, can be included at from 0.01 wt % to 10.0 wt %. Other vehicle components known in the art such as biocides, viscosity modifiers, materials for pH adjustment, sequestering agents, preservatives, latexes, polymers, and the like, can also be present.

Classes of solvents or co-solvents that can be used can include aliphatic alcohols, aromatic alcohols, diols, glycol ethers, polyglycol ethers, caprolactams, formamides, acetamides, and long chain alcohols. Examples of such compounds include primary aliphatic alcohols, secondary aliphatic alcohols, 1,2-alcohols, 1,3-alcohols, 1,5-alcohols, 1-6-alcohols, ethylene glycol alkyl ethers, propylene glycol alkyl ethers, polyethylene glycol alkyl ethers, substituted and unsubstituted lactams, N-alkyl caprolactams, unsubstituted caprolactams, both substituted and unsubstituted formamides, both substituted and unsubstituted acetamides, and the like. Specific examples of solvents that can be used include 1-(2-hydroxyethyl)-2-pyrrolidinone, 2-pyrrolidinone, and 1,6-hexanediol.

One or more of many surfactants can also be used as are known by those skilled in the art of ink formulation and may be alkyl polyethylene oxides, alkyl phenyl polyethylene oxides, polyethylene oxide block copolymers, acetylenic polyethylene oxides, polyethylene oxide (di)esters, polyethylene oxide amines, protonated polyethylene oxide amines, protonated polyethylene oxide amides, dimethicone copolyols, substituted amine oxides, and the like.

Consistent with the formulation of this invention, various other additives may be employed to optimize the properties of the ink composition for specific applications. Examples of these additives are those added to inhibit the growth of harmful microorganisms. These additives may be biocides, fungicides, and other microbial agents, which are routinely used in ink formulations. Examples of suitable microbial agents include, but are not limited to, Nuosept (Nudex, Inc.), Ucarcide (Union carbide Corp.), Vancide (R.T. Vanderbilt Co.), Proxel (ICI America), and combinations thereof.

Sequestering agents such as EDTA (ethylene diamine tetra acetic acid) may be included to eliminate the deleterious effects of heavy metal impurities, and buffer solutions may be used to control the pH of the ink. From 0.001% to 2.0% by weight, for example, of either of these components can be used. Viscosity modifiers and buffers may also be present, as well as other additives known to those skilled in the art to modify properties of the ink as desired. Such additives can be present at from 0.01% to 20% by weight.

### EXAMPLES

The following examples illustrate embodiments of the present invention. However, it is to be understood that the following are only exemplary or illustrative of the application of the principles of the present invention. Thus, these examples should not be considered as limitations of the present invention. Numerous modifications and alternative compositions, methods, and systems may be devised by those skilled in the art without departing from the spirit and scope of the present invention.

### Example 1

### Preparation of Exemplary Silica Dispersions Treated with Aminosilane and ACH

In a 3 liter stainless steel vessel was charged with 1265 g of deionized water, 28.8 g of ACH (50% solution from Clariant), and 43.2 g of n-butyl-3-aminopropyltrimethoxysilane (Dynasylan 1189 from Degussa). The mixture was sheared with a Kady lab rotor/stator at 30 Hz for 15 minutes. The pH of the solution was adjusted to 8.5 with acetic acid. About 480 g of Cabot MS-55 was added slowly to the mixture with shearing over 30 minutes. The temperature of the dispersion was kept under 40° C. with a chiller. After all silica was introduced, the dispersion was further sheared for 30 minutes at 60 Hz. The dispersion was heated to 70° C. for one hour to complete the conversion. Z-ave particle size measured by Malvern PCS was 109 nm.

### Example 2

### Preparation of Exemplary Silica Dispersions Treated with Aminosilane

In a 3 liter stainless steel vessel was charged with 1265 g of deionized water, and 43.2 g of n-butyl-3-aminopropyltrimethoxysilane (Dynasylan 1189 from Degussa). The mixture was sheared with a Kady lab rotor/stator at 30 Hz for 15 minutes. The pH of the solution was adjusted to 6.0 with acetic acid. About 480 g of Cabot MS-55 was added slowly to the mixture with shearing over 30 minutes. The temperature of the dispersion was kept under 40° C. with a chiller. After all silica was introduced, the dispersion was further sheared for 30 minutes at 60 Hz. The dispersion was heated to 70° C. for one hour to complete the conversion. Z-ave particle size measured by Malvern PCS was 119 nm. It is noted that surface area of fumed silica is dependent on the size of the primary particles and not on the aggregate size. The Z-ave size measured here is the aggregate size. Aggregate size is related to the fusion of primary particles. Example 1 and 2 have the same fumed silica (MS-55) so they have similar surface area, even though the aggregate size is slightly different because of the different treatment.

### Example 3

### Exemplary Silica Dispersions

TABLE 1

| | Silica | Surface | ACH | |
|---|---|---|---|---|
| | (parts by | Area | (parts by | Aminosilane |
| Silica ID | weight) | (m²/g) | weight) | (parts by weight) |
| Silica 1 | 100 parts | 255 m²/g | 3 parts | 9 parts |
| | (Cabot MS-55) | | | (Dynasylan 1189) |
| Silica 2 | 100 parts | 255 m²/g | 0 parts | 9 parts |
| | (Cabot MS-55) | | | (Dynasylan 1189) |
| Silica 3 | 100 parts | 300 m²/g | 0 parts | 10.8 parts |
| | (Orisil 300) | | | (Dynasylan 1189) |
| Silica 4 | 100 parts | 250 m²/g | 3 parts | 9 parts |
| | (Orisil 250) | | | (Dynasylan 1189) |
| Silica 5 | 100 parts | 250 m²/g | 0 parts | 10 parts |
| | (Orisil 250) | | | (Dynasylan 1189) |
| Silica 6 | 100 parts | 200 m²/g | 3.5 parts | 9.1 parts |
| | (Cabot M-5) | | | (Silquest A-1100) |
| Silica 7 | 100 parts | 300 m²/g | 3 parts | 9 parts |
| | (Orisil 300) | | | (Dynasylan 1189) |
| Silica 8 | 100 parts | 200 m²/g | 0 parts | 8.8 parts |
| | (Cabot M-5) | | | (Silquest A-1100) |

Dynasylan 1189 is n-butyl-3-aminopropyltrimethoxysilane by Degussa. Silquest A-1100 is 3-aminopropyltriethoxysilane by Gelest.

### Example 4

### Preparation of Porous Ink-Jet Media

Two layered porous ink-jet media sheets were produced with a wet-on-wet coating method with a slot die pilot coater. The type of the silica dispersions and the coat weight of the ink-jet receiving and ink-jet absorbing layer are described in Table 2, as follows:

TABLE 2

| | | Ink- | | Ink- | |
|---|---|---|---|---|---|
| | | Receiving | | Absorbing | Total |
| | Ink- | Layer | Ink- | Layer | Coat- |
| Media | Receiving | Coatweight | Absorbing | Coatweight | weight |
| ID | Layer | (g/m²) | Layer | (g/m²) | (g/m²) |
| 1 | Silica 7 | 15 | Silica 4 | 15 | 30 |
| 2 | Silica 7 | 10 | Silica 4 | 20 | 30 |
| 3 | Silica 3 | 15 | Silica 4 | 15 | 30 |
| 4 | Silica 3 | 10 | Silica 4 | 20 | 30 |
| 5 | Silica 7 | 15 | Silica 6 | 15 | 30 |
| 6 | Silica 7 | 10 | Silica 6 | 20 | 30 |
| 7 | Silica 3 | 15 | Silica 6 | 15 | 30 |
| 8 | Silica 5 | 15 | Silica 4 | 15 | 30 |
| 9 | Silica 5 | 10 | Silica 4 | 20 | 30 |
| 10 | Silica 5 | 15 | Silica 1 | 15 | 30 |
| 11 | Silica 5 | 10 | Silica 1 | 20 | 30 |
| 12 | Silica 5 | 15 | Silica 8 | 15 | 30 |
| 13 | Silica 5 | 10 | Silica 8 | 20 | 30 |
| 14 | Silica 2 | 15 | Silica 6 | 15 | 30 |
| 15 | Silica 2 | 10 | Silica 6 | 20 | 30 |
| 16 | Silica 2 | 15 | Silica 4 | 15 | 30 |
| 17 | Silica 2 | 10 | Silica 4 | 20 | 30 |
| 18 | Silica 8 | 15 | Silica 6 | 15 | 30 |
| 19 | Silica 8 | 10 | Silica 6 | 20 | 30 |
| 20 | Silica 1 | — | — | — | 30 |
| 21 | Silica 6 | — | — | — | 30 |

Media sheets 20 and 21 are single layered coating compositions provided for comparison purposes.

### Example 5

A 96 point test plot was imaged with a HP Photosmart A716 printer and HP Photosmart 8250 on each media sheet listed in Table 2. Color gamut and black density was measured with and the results are shown in Table 3, as follows:

TABLE 3

| | HP Photosmart A716 | | HP Photosmart 8250 | |
|---|---|---|---|---|
| Media ID | Gamut (×10⁻³) | L * min | Gamut (×10⁻³) | L * min |
| 5 | 487 | 14.7 | 457 | 3.7 |
| 6 | 487 | 15.0 | 466 | 3.5 |
| 7 | 491 | 15.7 | 462 | 4.4 |
| 14 | 488 | 15.7 | 463 | 3.8 |
| 15 | 497 | 16.0 | 472 | 3.6 |
| 18 | 469 | 15.2 | 451 | 5.0 |
| 19 | 477 | 15.0 | 454 | 5.0 |
| 21 | 430 | 17.5 | 429 | 7.5 |
| (Comparison | | | | |
| Media) | | | | |

In Table 3 above, the higher the gamut volume, the higher the color reproduction. The lower the L*min, the higher the black optical density. It is apparent from the data above that the two layered porous ink-jet media prepared in accordance with embodiments of the present invention has better color gamut and black density than single layered porous ink-jet media with same fumed silica and same treatment as the ink absorbing layer.

It is to be understood that the above-described formulations and arrangements are only illustrative of the application of the principles of the present invention. Numerous modifications and alternative arrangements may be devised by those skilled in the art without departing from the spirit and scope of the present invention and the appended claims are intended to cover such modifications and arrangements.

What is claimed is:

1. An ink-jet media sheet, comprising:
a substrate;
a porous ink-absorbing layer deposited on the media substrate, said porous ink-absorbing layer comprising metal oxide particulates or semi-metal oxide particulates, an organosilane reagent, and a trivalent or tetravalent metal salt;
a porous ink-receiving layer deposited on the porous ink-absorbing layer, said porous ink-receiving layer comprising metal oxide particulates or semi-metal oxide particulates, an organosilane reagent;
wherein the specific surface area of the metal oxide particulates or semi-metal oxide particulates of the porous ink-absorbing layer is less than or equal to that of the porous ink-receiving layer.

2. An ink-jet media sheet as in claim 1, wherein the specific surface area of the metal oxide particulates or semi-metal oxide particulates of the ink-absorbing layer is less than that of the ink-receiving layer.

3. An ink-jet media sheet as in claim 1, wherein the specific surface area of the metal oxide particulates or semi-metal oxide particulates in ink-absorbing layer is less than or equal to 300 m²/g and the specific surface area of the metal oxide particulates or semi-metal oxide particulates in ink-receiving layer is at least 200 m²/g.

4. An ink-jet media sheet as in claim 3, wherein the specific surface area of the metal oxide particulates or semi-metal oxide particulates of the porous ink-absorbing layer is less than the porous ink-receiving layer.

5. An ink-jet media sheet as in claim 1, wherein the metal oxide particulates or semi-metal oxide particulates of each layer is independently silica or alumina.

6. An ink-jet media sheet as in claim 1, wherein the metal oxide particulates or semi-metal oxide particulates of both layers is fumed silica, fumed alumina, precipitated silica, silica gel, colloidal silica, colloidal alumina, boehmite, or precipitated alumina.

7. An ink-jet media sheet as in claim 1, wherein the trivalent or tetravalent metal salt includes aluminum, chromium, gallium, titanium, or zirconium.

8. An ink-jet media sheet as in claim 1, wherein the trivalent or tetravalent metal salt is aluminum chlorohydrate.

9. An ink-jet media sheet as in claim 1, wherein the organosilane reagent in at least one the ink-absorbing layer or ink-receiving layer is an amine-functionalized silane.

10. An ink-jet media sheet as in claim 1, wherein the organosilane reagent in at least one the ink-absorbing layer or ink-receiving layer is a mono-, di-, or tri aminosilane.

11. An ink-jet media sheet as in claim 1, wherein the organosilane reagent in at least one of the ink-absorbing layer or ink-receiving layer is selected from 3-aminopropyltrimethoxysilane, 3-aminopropyltriethoxysilane, 3-aminoethylaminopropyltrimethoxysilane, 3-aminoethylaminopropyltriethoxysilane, 3-aminoethylaminoethylaminopropyltrimethoxysilane, 3-aminoethylaminoethylaminopropyltriethoxysilane, 3-aminopropylsilsesquioxane, (n-Butyl)-3-aminopropyltrimethoxysilane, (n-Butyl)-3-aminopropyltriethoxysilane, bis-(3-trimethoxysilylpropyl)amine, N-benzyl-N-aminoethyl-3-aminopropyltrimethoxysilane hydrochloride, N-phenyl-3-aminopropyltrimethoxysilane, N-(2-aminoethyl-3-aminopropyltrimethoxysilane, 3-(triethoxysilylpropyl)-diethylenetriamine, and poly(ethyleneimine) trimethoxysilane.

12. An ink-jet media sheet as in claim 1, wherein the ink-absorbing layer comprises metal oxide particulates or semi-metal oxide particulates, an amine-functionalized silane, and an aluminum chlorohydrate.

13. An ink-jet media sheet as in claim 12, wherein the amine-functionalized silane is from 0.5 wt % to 20 wt % and the aluminum chlorohydrate is from 0.5 wt % to 10 w % based on the weight of the metal oxide or semi-metal oxide particulates.

14. An ink-jet media sheet as in claim 1, wherein the porous ink-receiving layer comprises metal oxide particulates or semi-metal oxide particulates, and an amine-functionalized silane.

15. An ink-jet media sheet as in claim 14, wherein the amine-functionalized silane is from 0.5 wt % to 20 wt % based on the weight of the metal oxide particulates or semi-metal oxide particulates.

16. An ink-jet media sheet as in claim 1, wherein the porous ink-receiving layer is deposited on the porous ink-receiving layer at from 1 g/m² to 20 g/m², and the porous ink-absorbing layer is deposited on the substrate at from 5 g/m² to 30 g/m².

17. An ink-jet media sheet as in claim 1, wherein at least one of the ink-receiving layer and the ink-absorbing layer further comprises a binder present in the layer in an amount from about 0.1 wt % to about 40 wt %, wherein the binder is independently selected from the group consisting of polyvinyl alcohols; water-soluble copolymers of polyvinyl alcohols including copolymer of polyvinyl alcohol and poly(ethylene oxide) and copolymer of polyvinyl alcohol and polyvinyl amine; cationic polyvinyl alcohols; acetoacetylated polyvinyl alcohols; polyvinyl acetate, polyvinyl pyrrolidone; modified starches; water soluble cellulose derivatives; polyacrylamides; casein; gelatin; soybean protein; silyl-modified polyvinyl alcohol; conjugated diene copolymer latexes; acrylic polymer latexes; vinyl polymer latexes; functional group-modified latexes; aqueous binders of thermosetting resins; synthetic resin; and combinations thereof.

18. An ink-jet media sheet as in claim 1, wherein the ink-receiving layer also includes a trivalent or tetravalent metal salt.

19. A method of preparing an ink-jet media sheet, comprising:
applying a porous ink-absorbing layer on a media substrate at from 5 g/m² to 30 g/m², said porous ink-absorbing layer comprising metal oxide particulates or semi-metal oxide particulates, an organosilane reagent, and a trivalent or tetravalent metal salt; and
applying a porous ink-receiving layer on the porous ink-absorbing layer at from 1 g/m² to 20 g/m², said porous ink-receiving layer comprising metal oxide particulates or semi-metal oxide particulates and an organosilane reagent.

20. A method as in claim 19, wherein the specific surface area of the metal oxide particulates or semi-metal oxide particulates of the ink-absorbing layer is less than that of the ink-receiving layer.

21. A method as in claim 19, wherein the specific surface area of the metal oxide particulates or semi-metal oxide particulates in ink-absorbing layer is equal or less than 250 m²/g and the specific surface area of the metal oxide particulates or semi-metal oxide particulates in ink-receiving layer is at least 200 m²/g, with the proviso that the specific surface area of the ink-absorbing layer is less than the specific surface area of the ink-receiving layer.

22. A method as in claim 19, wherein the metal oxide particulates or semi-metal oxide particulates of each layer is independently silica or alumina.

23. A method as in claim 19, wherein the metal oxide particulates or semi-metal oxide particulates of both layers is fumed silica, fumed alumina, precipitated silica, silica gel, colloidal silica, colloidal alumina, boehmite, or precipitated alumina.

24. A method as in claim 19, wherein the trivalent or tetravalent metal salt includes aluminum, chromium, gallium, titanium, or zirconium.

25. A method as in claim 19, wherein the trivalent or tetravalent metal salt is aluminum chlorohydrate.

26. A method as in claim 19, wherein the organosilane reagent in at least one the ink-absorbing layer or ink-receiving layer is an amine-functionalized silane.

27. A method as in claim 19, wherein the organosilane reagent in at least one the ink-absorbing layer or ink-receiving layer is a mono-, di-, or tri aminosilane.

28. A method as in claim 19, wherein the organosilane reagent in at least one of the ink-absorbing layer or ink-receiving layer is selected from 3-aminopropyltrimethoxysilane, 3-aminopropyltriethoxysilane, 3-aminoethylaminopropyltrimethoxysilane, 3-aminoethylaminopropyltriethoxysilane, 3-aminoethylaminoethylaminopropyltrimethoxysilane, 3-aminoethylaminoethylaminopropyltriethoxysilane, 3-aminopropylsilsesquioxane, (n-Butyl)-3-aminopropyltrimethoxysilane, (n-Butyl)-3-aminopropyltriethoxysilane, bis-(3-trimethoxysilylpropyl)amine, N-benzyl-N-aminoethyl-3-aminopropyltrimethoxysilane hydrochloride, N-phenyl-3-aminopropyltrimethoxysilane, N-(2-aminoethyl-3-aminopropyltrimethoxysilane, 3-(triethoxysilyl propyl)-diethylenetriamine, and poly(ethyleneimine) trimethoxysilane.

29. A method as in claim 19, wherein the ink-absorbing layer comprises metal oxide particulates or semi-metal oxide particulates, an amine-functionalized silane, and an aluminum chlorohydrate.

30. A method as in claim 29, wherein the amine-functionalized silane is from 0.5 wt % to 20 wt % and the aluminum chlorohydrate is from 0.5 wt % to 10 w % based on the weight of the metal oxide or semi-metal oxide particulates.

31. A method as in claim 19, wherein the porous ink-receiving layer comprises metal oxide particulates or semi-metal oxide particulates, and an amine-functionalized silane.

32. A method as in claim 31, wherein the amine-functionalized silane is from 0.5 wt % to 20 wt % based on the weight of the metal oxide particulates or semi-metal oxide particulates.

34. A method as in claim 1, wherein at least one of the ink-receiving layer and the ink-absorbing layer further comprises a binder present in the layer in an amount from about 0.1 wt % to about 40 wt %, wherein the binder is independently selected from the group consisting of polyvinyl alcohols; water-soluble copolymers of polyvinyl alcohols including copolymer of polyvinyl alcohol and poly(ethylene oxide) and copolymer of polyvinyl alcohol and polyvinyl amine; cationic polyvinyl alcohols; acetoacetylated polyvinyl alcohols; polyvinyl acetate, polyvinyl pyrrolidone; modified starches; water soluble cellulose derivatives; polyacrylamides; casein; gelatin; soybean protein; silyl-modified polyvinyl alcohol; conjugated diene copolymer latexes; acrylic polymer latexes; vinyl polymer latexes; functional group-modified latexes; aqueous binders of thermosetting resins; synthetic resin; and combinations thereof.
